(19) United States
(12) Patent Application Publication
(10) Pub. No.: US 2008/0103806 A1
(43) Pub. Date: May 1, 2008

(54) METHOD AND SYSTEM FOR DOCUMENTING AND COMMUNICATING AUTOMOBILE REPAIR AND MAINTENANCE HISTORY

(76) Inventor: John Billie Harris, Hoover, AL (US)

Correspondence Address: BUSH INTELLECTUAL PROPERTY LAW GROUP, LLC, P.O. BOX 381146, BIRMINGHAM, AL, 35238, US

(21) Appl. No.: 11/931,412

(22) Filed: Oct. 31, 2007

Related U.S. Application Data
(60) Provisional application No. 60/855,470, filed on Oct. 31, 2006.

(51) Int. Cl. G06Q 50/00; G06F 17/30; G06F 17/40

(52) U.S. Cl. 705/1

(57) ABSTRACT

A method for providing historical vehicle service data by entering vehicle service and parts replacement data and customer data by a service provider into a website; transferring the vehicle service and parts replacement data and the customer data from the website to a central server which creates the historical vehicle service data; providing notification by the central server to a vehicle manufacturer information on defective parts, to a parts supplier information on replaced parts, and to a service provider the time of the next scheduled service for a given vehicle; and accessing the website by a customer for the historical vehicle service data on the customer's vehicle, and by a vehicle dealer and/or financial institution for the historical vehicle service data on any vehicle.

### REFERENCE TO RELATED APPLICATION

The present application claims priority to U.S. Provisional Patent Application Ser. No. 60/855470, filed on Oct. 31, 2006, the disclosure of which is incorporated herein by reference.

### FIELD OF THE INVENTION

The present invention relates generally to computer-based vehicle repair administration systems. More particularly, the present invention relates to a computer network based repair administration system and method that documents and communicates automobile repair and maintenance history.

### BACKGROUND OF THE INVENTION

A customer will arrive at an automobile repair shop or service center and request automobile services. The service advisor will make a brief determination of the necessary parts and labor needed to complete the repair after performing a preliminary evaluation of what the customer needs. The service advisor performs a repair estimate, creates an initial repair order, dispatches the work to a service technician, and monitors the progress of repair. The service advisor also communicates the progress of repair back to the customer and serves as a point of contact. Upon completion of the servicing, the service advisor explains the services performed and supervises the return of the vehicle to the owner.

A significant amount of valuable information is acquired during the process of an automobile service provider repairing and maintaining automobiles. Over time, a historical database can be created regarding the repair and maintenance history for any given customer and for any given model and year of any automobile as services are provided. This information has monetary value in that there is a demand for such information by customers, parts suppliers, automobile manufacturers, automobile dealers, and insurance companies. However, the time and effort required to document, store, retrieve, and communicate this information is excessively expensive for the broad, rapid commercial distribution of such information. Although information can be exchanged rapidly and cheaply over the Internet, the internet has not heretofore been useful in the dissemination of historical data related to automobile repair and maintenance.

The popularity of the Internet has promoted development of improved standards in communication technology. One such standard is “HTTP” or Hypertext Transmission Protocol. HTTP is the underlying protocol that allows information to flow through the World Wide Web of the Internet. Specifically, http allows the transfer of information between dissimilar types of computers, enabling any computer system that can process HTTP to communicate with any computer in the world that can also process HTTP, regardless of the specific computer architecture, operating system, or spoken language. By using HTTP equipment and inventory systems at different locations one can use common information databases and exchange information or share data easily. Furthermore, individuals at remote locations can communicate in real time with a computer located at a repair or service site. The most notable characteristic of the Internet in current times is that it easily enables information to be requested and retrieved from virtually anywhere. Once a user has installed a Web browser on his computer and is connected to the Internet through an Internet service provider (ISP) he can access a Web page from any World Wide Web (WWW) server throughout the world. There is no need for special configuration or compatibility requirements because of the universal nature of the communication standards. What is needed is a method and system that can take advantage of the Internet system to document, store, retrieve, and communicate automobile repair and maintenance history rapidly at a reasonable cost as part of the business process of automobile repair shops and service centers.

### SUMMARY OF THE INVENTION

The present invention is a method and system for documenting and communicating vehicle repair, maintenance, and parts replacement history, in addition to providing notifications regarding one or more vehicles. A computer-network system is used to implement the method. The method includes entering vehicle service and parts replacement data by a service provider into a website; transferring the data from the website to a central server; providing notification by the central server to a vehicle manufacturer information on defective parts; to a parts supplier information on replaced parts; and to a service provider the time of the next scheduled service for a given vehicle; and accessing the website by a customer for historical data on the customer's vehicle, and by a dealer and/or insurance company for historical vehicle service data. The owner of the website and server system can offer subscriptions for a fee to allow access to the website and for providing vehicle service and parts replacement data.

An advantage of the present invention is a system and method that rapidly and efficiently documents and communicates vehicle repair, maintenance, and parts replacement history, in addition to providing notifications regarding one or more vehicles.

Another advantage is a system and method that allows a large number of various users such as service providers, manufacturers, dealers, financial institutions, parts suppliers and customers of service providers to access a single website to obtain historical data on vehicle maintenance and repair.

Another advantage is a system and method that makes use of the Internet system and World Wide Web to document, store, retrieve, and communicate automobile repair and maintenance history rapidly and profitably at a reasonable cost as part of the business process of automobile repair shops and service centers.

### BRIEF DESCRIPTION OF THE DRAWINGS

FIG. 1 illustrates a computer-network system used to implement the method of the present invention.

FIG. 2 illustrates the steps in the method of the present invention.

### DETAILED DESCRIPTION OF THE PREFERRED EMBODIMENTS

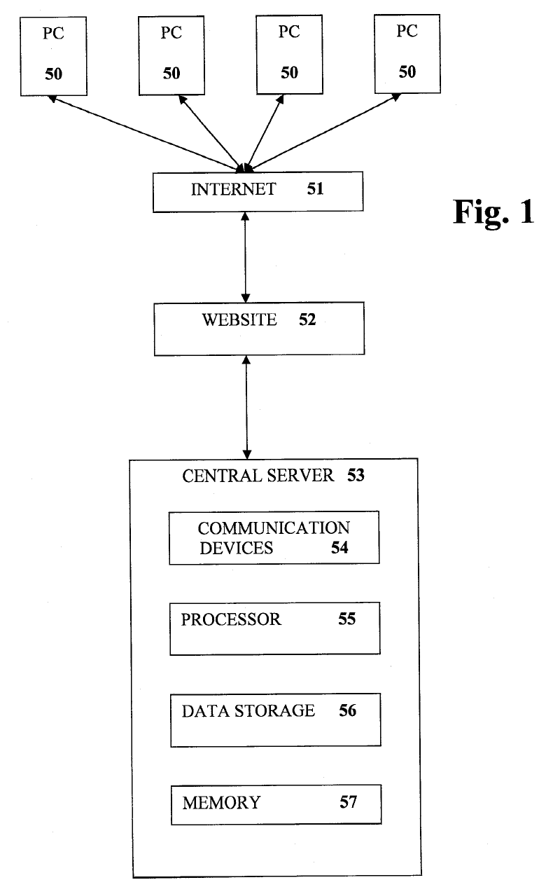

The present invention is a computer-network repair administration system that documents and communicates automobile repair and maintenance history. As shown in FIG. 1, the method is implemented from a central server 53 through a communication network such as the Internet 51. The central server 53 has communication devices 54 which allow the central server 53 to communicate by telephone, cable, or satellite, and the like. The central server 53 also has a processor 55, data storage 56 and memory 57, and is linked to the Internet 51, or other communication networks. The central server 53 implements required software programs well known in the art and maintains a website 52 on the Internet 51. The website 52 can be accessed by users through computers and related devices, such as personal computers (PCs) 50, by methods well known in the art.

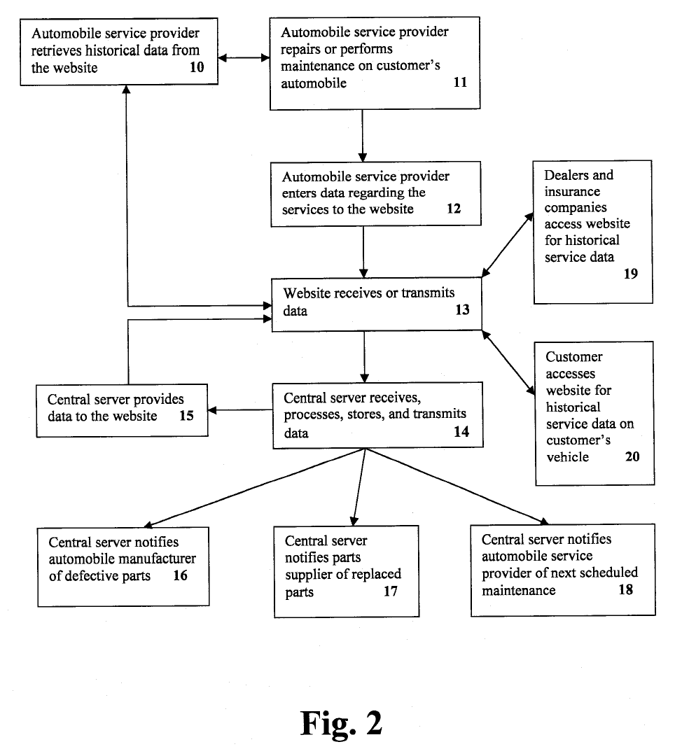

FIG. 2 illustrates the method of the present invention for providing historical vehicle service data. When a customer brings his or her automobile to an automobile service center for repair or maintenance, the automobile service provider can access the service center's website 52 on the Internet 51 to see if there is any historical data on the customer's automobile which is available for retrieval and review (step 10). The automobile service provider repairs or performs maintenance on the customer's automobile as needed (step 11). The automobile service provider then enters data regarding the services provided to the customer's automobile using the automobile service center's website 52 (step 12). The website 52 transmits data to the automobile service center's central server 53 (step 13) which receives, processes, stores, and transmits the data as desired (step 14). In particular, the central server 53 provides data to the website 52 regarding the history of repairs and maintenances for each customer's automobile (step 15).

The central server 53 can automatically notify various entities electronically regarding services and maintenance on customers' automobiles using, for example, email. For example, the central server 53 can notify automobile manufacturers of defective parts discovered in the process of repair or maintenance (step 16). The central server 53 can notify a parts supplier of replaced parts and the status of the service center's parts inventory (step 17). The central server 53 can notify the automobile service provider of any customer's next scheduled maintenance (step 18). Dealerships can access the website 52 to obtain vehicle repair and maintenance history in response to consumer inquiries on other vehicles, and insurance companies and other financial institutions can access the website 52 to obtain vehicle repair and maintenance history for documentation of accident claims and the like on any vehicle (step 19). Consumers can access the website 52 to obtain vehicle repair and maintenance history for their own personal vehicles (step 20). The owner of the website and server system can offer subscriptions for a fee to allow access to the website and for providing vehicle service and parts replacement data.

### Example of Website Usage

An administrator designs the website 52 to authorize users to access the website and use hyperlinks to enter and obtain data. Hyperlinks to various functions on the website 52 include Add New Vehicle, Add Service Record, Reports, and Users.

When Add New Vehicle is selected a user, such as a technician, enters a vehicle identification number, year, and make of a vehicle (vehicle data) and any information about the customer. When this data is entered the user has the options of reviewing vehicle history of previous repair/maintenance service and parts replacement, and selecting a service to be provided. When a service to be provided is selected the fee for the service is shown and the user can select parts to be used for the service. The cost of the parts is also shown. The user then adds the service record which displays service details, including parts replacement, vehicle data, customer data, and costs. A user can continue to use these options when Add Service Record is selected. This link is selected when the new vehicle is brought to the service center for additional service. The user, such as a technician, can select Vehicle Service History which then displays data previously entered by the technician including date, name and location of the service provider, mileage, technician name, service, and parts. The user (technician) then adds the new service record after the service and parts are selected, which again displays service details, vehicle data, customer data, and costs.

When a user selects the Report hyperlink the user can obtain a report on Frequently Replaced Parts, Previous Owner Report, Services Performed per Automobile, Services Performed by Service Center, and Usage Report by User. When Previous Owner Report is selected data on the vehicle and customer is displayed. When Services Performed per Vehicle Report is selected the date, location, mileage, technician name, service and parts, and costs are displayed. When Frequently Replaced Parts Report is selected data on the parts and number of replacements is displayed. When Services by Center Report is selected a list of all the services performed is displayed. When Usage Report by User is selected, the number of times a user has accessed the website and corresponding dates are displayed.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, any type of vehicle (cars, boats, trains, plains, buses, and the like), service, and parts can be recorded and tracked in the method and system of the present invention. Any type of computer and communication system, including wireless communication system, can be used to enter and retrieve information from the website and server.

It will be understood that various changes in the details, materials, and arrangements of the parts which have been described and illustrated above in order to explain the nature of this invention may be made by those skilled in the art without departing from the principle and scope of the invention as recited in the following claims.

1. A method for providing historical vehicle service data, comprising the steps of:
1) entering vehicle service and parts replacement data and customer data by a service provider into a website;
2) transferring said vehicle service and parts replacement data and said customer data from said website to a central server which creates said historical vehicle service data;
3) providing notification by said central server to a vehicle manufacturer information on defective parts; to a parts supplier information on replaced parts; and to a service provider the time of the next scheduled service for a given vehicle; and
4) accessing said website by a customer for said historical vehicle service data on said customer's vehicle, and by a vehicle dealer and/or financial institution for said historical vehicle service data on any vehicle.

2. The method of claim 1, further comprising the steps of retrieving said historical vehicle service data of a customer's vehicle from said website by said service provider performing service on said customer's vehicle and performing step 1.

3. The method of claim 1 wherein the step of entering vehicle service and parts replacement data includes entering the date, name and location of said service provider, vehicle data, mileage, technician name, service details, parts, and costs.

4. The method of claim 1 wherein said central server analyzes said historical vehicle service data and creates reports which can be accessed through said website.

5. The method of claim 4 wherein said reports include reports on frequently replaced parts, previous owner, services performed per vehicle, services performed by service center, and usage of said website by a user.

6. A method for providing historical vehicle service data, comprising the steps of:
1) entering vehicle service and parts replacement data and customer data by a service provider into a website;
2) transferring said vehicle service and parts replacement data and said customer data from said website to a central server which creates said historical vehicle service data;
3) providing notification by said central server to a vehicle manufacturer information on defective parts; to a parts supplier information on replaced parts; and to a service provider the time of the next scheduled service for a given vehicle;
4) accessing said website by a customer for said historical vehicle service data on said customer's vehicle, and by a vehicle dealer and/or financial institution for said historical vehicle service data on any vehicle; and
5) retrieving said historical vehicle service data of a customer's vehicle from said website by said service provider performing service on said customer's vehicle and performing step 1.

7. The method of claim 6 wherein the step of entering vehicle service and parts replacement data includes entering the date, name and location of said service provider, vehicle data, mileage, technician name, service details, parts, and costs.

8. The method of claim 6 wherein said central server analyzes said historical vehicle service data and creates reports which can be accessed through said website

9. The method of claim 8 wherein said reports include reports on frequently replaced parts, previous owner, services performed per vehicle, services performed by service center, and usage of said website by a user.

10. A method for providing historical vehicle service data, comprising the steps of:
1) entering vehicle service and parts replacement data and customer data by a service provider into a website;
2) transferring said vehicle service and parts replacement data and said customer data from said website to a central server which creates and analyzes said historical vehicle service data, and creates reports which can be accessed through said website;
3) providing notification by said central server to a vehicle manufacturer information on defective parts; to a parts supplier information on replaced parts; and to a service provider the time of the next scheduled service for a given vehicle;
4) accessing said website by a customer for said historical vehicle service data on said customer's vehicle, and by a vehicle dealer and/or financial institution for said historical vehicle service data on any vehicle; and
5) retrieving said historical vehicle service data of a customer's vehicle from said website by said service provider performing service on said customer's vehicle and performing step 1.

11. The method of claim 10 wherein the step of entering vehicle service and parts replacement data includes entering the date, name and location of said service provider, vehicle data, mileage, technician name, service details, parts, and costs.

12. The method of claim 11 wherein said reports include reports on frequently replaced parts, previous owner, services performed per vehicle, services performed by service center, and usage of said website by a user.

13. A method for providing historical vehicle service data, comprising the steps of:
1) entering vehicle service and parts replacement data and customer data by a service provider into a website, including entering the date, name and location of said service provider, vehicle data, mileage, technician name, service details, parts, and costs;
2) transferring said vehicle service and parts replacement data and said customer data from said website to a central server which creates and analyzes said historical vehicle service data, and creates reports which can be accessed through said website;
3) providing notification by said central server to a vehicle manufacturer information on defective parts; to a parts supplier information on replaced parts; and to a service provider the time of the next scheduled service for a given vehicle;
4) accessing said website by a customer for said historical vehicle service data on said customer's vehicle, and by a vehicle dealer and/or financial institution for said historical vehicle service data on any vehicle; and
5) retrieving said historical vehicle service data of a customer's vehicle from said website by said service provider performing service on said customer's vehicle and performing step 1.

14. The method of claim 13 wherein said reports include reports on frequently replaced parts, previous owner, services performed per vehicle, services performed by service center, and usage of said website by a user.
